(19) United States
(12) Patent Application Publication
(10) Pub. No.: US 2025/0278006 A1
(43) Pub. Date: Sep. 4, 2025

(54) WAVE SWITCHING FOR ELECTRO-OPTIC DISPLAYS

(71) Applicant: E INK CORPORATION, Billerica, MA (US)

(72) Inventor: George G. HARRIS, Woburn, MA (US)

(21) Appl. No.: 19/060,398

(22) Filed: Feb. 21, 2025

Related U.S. Application Data
(60) Provisional application No. 63/559,515, filed on Feb. 29, 2024.

(51) Int. Cl. G02F 1/1685; G02F 1/167; G02F 1/1676

(52) U.S. Cl. CPC G02F 1/1685; G02F 1/167; G02F 1/1676

(57) ABSTRACT

Methods for driving “spaced contact” electro-optic displays and “isolated electrode” electro-optic displays, such as electrophoretic displays including charged pigment particles disposed in a solvent that move in response to applied electric fields. The improved methods provide “wave switching” waveforms that have less visual “dead time” than prior art wave switching methods. The improved methods provide DC balanced waveforms that allow for a banner-type display to wave switch from a first color to a second color in a first direction and then return to the first color from the second color in an opposite direction. Such switching was not viable in prior art devices for fear of runaway remnant voltage build up that can destroy the display.

### REFERENCE TO RELATED APPLICATIONS

This application claims priority to U.S. Provisional Application No. 63/559,515, filed Feb. 29, 2024. All patents and publications described herein are incorporated by reference in their entireties.

### FIELD OF THE INVENTION

The present invention relates to methods for driving electro-optic displays, especially bistable electro-optic displays. This invention is especially, but not exclusively, intended for use with particle-based electrophoretic displays in which one or more types of electrically charged particles are present in a fluid and are moved through the fluid under the influence of an electric field to change the appearance of the display. The methods described herein allow an electrophoretic display to appear to change optical state from one side of the display to another, travelling as a “wave” of color change across the display. Such methods are especially valuable in digital signage, e.g., segmented digital signage, where the wave update draws a viewer's attention to the sign.

### BACKGROUND OF THE INVENTION

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, and luminescence or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states. The methods described herein are not limited to black and white displays, and may be used with displays capable of displaying many different colors, such as three, four, five, six, seven, eight, nine, ten, eleven, twelve, thirteen, fourteen, fifteen, sixteen, or more colors.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

The term “impulse” is used herein in its conventional meaning of the integral of voltage with respect to time. However, some bistable electro-optic media act as charge transducers, and with such media an alternative definition of impulse, namely the integral of current over time (which is equal to the total charge applied) may be used. The appropriate definition of impulse should be used, depending on whether the medium acts as a voltage-time impulse transducer or a charge impulse transducer.

Much of the discussion below will focus on methods for driving an electro-optic display through a transition from an initial gray level to a final gray level (which may or may not be different from the initial gray level). The term “waveform” will be used to denote the entire voltage against time curve used to affect the transition from one specific initial gray level to a specific final gray level. Such a waveform may comprise a plurality of waveform elements; where these elements are essentially rectangular (i.e., where a given element comprises application of a constant voltage for a period of time); the elements may be called “pulses” or “drive pulses”. The term “drive scheme” denotes a set of waveforms sufficient to affect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible to use more than one drive scheme simultaneously in different areas of the same display, and a set of drive schemes used in this manner may be referred to as “a set of simultaneous drive schemes.”

One type of electro-optic display, which has been the subject of intense research and development is the particle-based electrophoretic display, in which a plurality of charged particles moves through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in the these patents and applications include:
(a) Electrophoretic particles, fluids and fluid additives; see for example U.S. Pat. Nos. 7,002,728; and 7,679,814;
(b) Capsules, binders and encapsulation processes; see for example U.S. Pat. Nos. 6,922,276; and 7,411,719;
(c) Films and sub-assemblies containing electro-optic materials; see for example U.S. Pat. Nos. 6,982,178; and 7,839,564;
(d) Backplanes, adhesive layers and other auxiliary layers and methods used in displays; see for example U.S. Pat. Nos. 7,116,318; and 7,535,624;
(e) Color formation and color adjustment; see for example U.S. Pat. Nos. 7,075,502; and 7,839,564;
(f) Methods for driving displays; see the aforementioned MEDEOD applications;
(g) Applications of displays; see for example U.S. Pat. Nos. 7,312,784; and 7,312,784; and
(h) Non-electrophoretic displays, as described in U.S. Pat. Nos. 6,241,921; 6,950,220; 7,420,549 8,319,759; and U.S. Pat. Nos. 8,994,705 and 10,372,008.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449, both assigned to SiPix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

Other types of electro-optic media may also be used in the displays of the present invention.

The bistable or multi-stable behavior of particle-based electrophoretic displays, and other electro-optic displays displaying similar behavior (such displays may hereinafter for convenience be referred to as “impulse driven displays”), is in marked contrast to that of conventional liquid crystal (“LC”) displays. Twisted nematic liquid crystals are not bi- or multi-stable but act as voltage transducers, so that applying a given electric field to a pixel of such a display produces a specific gray level at the pixel, regardless of the gray level previously present at the pixel. Furthermore, LC displays are only driven in one direction (from non-transmissive or “dark” to transmissive or “light”), the reverse transition from a lighter state to a darker one being affected by reducing or eliminating the electric field. Finally, the gray level of a pixel of an LC display is not sensitive to the polarity of the electric field, only to its magnitude, and indeed for technical reasons commercial LC displays usually reverse the polarity of the driving field at frequent intervals. In contrast, bistable electro-optic displays act, to a first approximation, as impulse transducers, so that the final state of a pixel depends not only upon the electric field applied and the time for which this field is applied, but also upon the state of the pixel prior to the application of the electric field.

Whether or not the electro-optic medium used is bistable, to obtain a high-resolution display, individual pixels of a display must be addressable without interference from adjacent pixels. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary, and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a voltage such as to ensure that all the transistors in the selected row are conductive, while there is applied to all other rows a voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.) After a pre-selected interval known as the “line address time” the selected row is deselected, the next row is selected, and the voltages on the column drivers are changed so that the next line of the display is written. This process is repeated so that the entire display is written in a row-by-row manner.

Alternatively, with an electro-optic medium that has a substantial threshold voltage (which most electrophoretic media do not) passive matrix driving may be used. In this type of driving, two sets of parallel elongate electrodes are provided on opposed sides of the electro-optic layer, with the two sets of electrodes being arranged perpendicular to each other, so that each pixel is defined by the intersection of one electrode in each of the two sets. Finally, electro-optic displays can make use of so-called “direct driving”, in which a plurality of pixels are each provided with a separate conductor linking a pixel electrode to a display controller, which can thus directly control the potential of each pixel electrode.

Active and passive matrix displays are complicated and costly, especially in the case of large area displays, since the cost of the necessary electrodes tends to be a function of display area rather than number of pixels. However, active and passive matrix displays do have the flexibility to display any image and can thus represent both pictures and text of varying point sizes. Direct drive displays tend to be less expensive, but lack flexibility, and if capable of displaying text typically are limited to a single point size and require a very large number of connections between the pixel electrodes and the controller; see, for example, U.S. Design Patent No. D485,294, which requires 63 pixels to represent one character of various versions of the Latin alphabet in a single point size.

Hitherto, most commercial applications of electrophoretic and similar bistable electro-optic displays have been in small products, such as electronic document readers, watches and solid-state memory devices. However, there is increasing interest in applying such displays to furniture and architectural applications. In many furniture and architectural applications, the electro-optic display is intended to provide simple, typically moving, geometric patterns. The present invention seeks to provide displays and driving methods useful in furniture and architectural applications. Additionally, the described waveforms allow for “back and forth” wave switching of a type not previously available with prior art wave switching, i.e., as described in U.S. Pat. Nos. 10,197,883 and 10,551,713, which are incorporated by reference in their entireties.

As discussed in several of the applications mentioned above, if the waveform applied to an electro-optic display is not DC balanced, damage to the electrodes may result, especially in the case of light-transmissive electrodes, which are typically very thin, less than 1 μm. (The term “light-transmissive” is used herein in its conventional meaning in the display art, as described for example in U.S. Pat. No. 6,982,178, to mean transmitting sufficient visible light to enable an observer viewing the electro-optic material through the light-transmissive electrode to observe changes in the optical state of the electro-optic material.) To reduce or eliminate such damage to electrodes, at least part of one of the first and second electrodes may be provided with a passivation layer disposed between the electrode and the layer of electro-optic material. Appropriate passivation layers are described in, for example, U.S. Pat. No. 6,724,519. However, in order to further prevent the likelihood of damage to the electrodes, there is a need for the development of DC balanced waveforms used in the operation of electro-optic displays. Such damage may cause the display to show incorrect colors, or the display may cease functioning altogether.

### SUMMARY OF INVENTION

The present invention provides improved methods for driving a spaced contact display, for example, a spaced contact electrophoretic display, wherein the spaced contact display comprises a layer of electro-optic material, and first and second electrodes on opposed sides of the layer of electro-optic material, at least one of the first and second electrodes being light-transmissive, and at least one of the first and second electrodes having at least two spaced contacts, and a voltage controller arranged to provide driving voltage signals between the two spaced contacts attached to the same electrode.

In a first aspect, the invention is a method for driving a spaced contact electro-optic display, comprising providing a spaced contact electro-optic display including a layer of electro-optic material, first and second electrode layers on opposed sides of the layer of electro-optic material wherein the first or the second electrode layer is light-transmissive, first and second contacts spaced apart on, and electrically coupled to, the first electrode layer, and a voltage controller coupled to the first and second contacts; providing a first time-varying drive signal to the first contact with the voltage controller, wherein the first time-varying drive signal begins at a duty cycle of zero, ramps to a duty cycle of 1, and then returns to a duty cycle of zero; and providing a second time-varying drive signal to the second contact with the voltage controller, wherein the second time-varying drive signal begins at a duty cycle of zero, ramps to a duty cycle of −1, then ramps to a duty cycle of 1, and then returns to a duty cycle of zero. In some embodiments, the ramp from a duty cycle of −1 to a duty cycle of 1 for the second time-varying drive signal includes two different slopes of duty cycle per unit of time. In some embodiments, the method further comprises: providing a third time-varying drive signal to the first contact with the voltage controller, wherein the first time-varying drive signal begins at a duty cycle of zero, ramps to a duty cycle of −1, and then returns to a duty cycle of zero; and providing a fourth time-varying drive signal to the second contact with the voltage controller, wherein the second time-varying drive signal begins at a duty cycle of zero, ramps to a duty cycle of 1, then ramps to a duty cycle of −1, and then returns to a duty cycle of zero. In some embodiments, the first time-varying drive signal and the second time-varying drive signal reach a duty cycle of 1 at the same time. In some embodiments, the frequency of the first and second drive signals is 30 Hz or greater. In some embodiments, the magnitude of the voltage of the first and second drive signals is from 15V to 30V. In some embodiments, both the first and second electrodes have at least two spaced contacts and the voltage controller is arranged to vary the potential differences between of the two spaced contacts attached to each electrode. In some embodiments, the electro-optic material comprises an electrophoretic material comprising a plurality of electrically charged particles disposed in a fluid and capable of moving through the fluid under the influence of an electric field. In some embodiments, the electrically charged particles and the fluid are confined within a plurality of capsules or microcells or discrete droplets surrounded by a continuous phase comprising a polymeric material. In some embodiments, at least one of the first and second electrodes is interrupted by at least one non-conductive area such that electrical current must follow a non-linear path between the two contacts on that electrode. In some embodiments, at least one of the first and second electrodes is divided into a plurality of sections having differing electrical resistance per unit length. In some embodiments, at least one of the first and second electrodes is divided into a plurality of sections having differing electrical capacitance per unit area. In some embodiments, at least part of one of the first and second electrodes is provided with a passivation layer disposed between the electrode and the layer of electro-optic material. In some embodiments, the first or second time-varying drive signal comprises a sine wave, a triangular wave, a saw tooth wave, or a square wave.

In another aspect, the invention provides a method for driving a spaced contact electro-optic display, comprising: providing a spaced contact electro-optic display including: a layer of electro-optic material, first and second electrode layers on opposed sides of the layer of electro-optic material wherein the first or the second electrode layer is light-transmissive, first and second contacts spaced apart on, and electrically coupled to, the first electrode layer, and a voltage controller coupled to the first and second contacts; providing a first time-varying drive signal to the first contact with the voltage controller, wherein the first time-varying drive signal begins at a duty cycle of zero, ramps to a duty cycle of −1, maintains a duty cycle of −1 for a sufficient time to provide DC balance to the first time-varying drive signal, then ramps to a duty cycle of 1, and then returns to a duty cycle of zero; and providing a second time-varying drive signal to the second contact with the voltage controller, wherein the second time-varying drive signal begins at a duty cycle of zero, transitions to a duty cycle of 1 by going through negative duty cycle impulses until the first time-varying drive signal is maintained a duty cycle of −1 and then proceeds to a duty cycle of 1, and then returns to a duty cycle of zero. In some embodiments, the method further comprises: providing a third time-varying drive signal to the first contact that is identical to the second time-varying drive signal; and providing a fourth time-varying drive signal to the second contact that is identical to the first time-varying drive signal. In some embodiments, the first time-varying drive signal and the second time-varying drive signal reach a duty cycle of 1 at the same time. In some embodiments, the frequency of the first and second drive signals is 30 Hz or greater. In some embodiments, the magnitude of the voltage of the first and second drive signals is from 15V to 30V. In some embodiments, both the first and second electrodes have at least two spaced contacts and the voltage controller is arranged to vary the potential differences between of the two spaced contacts attached to each electrode. In some embodiments, the electro-optic material comprises an electrophoretic material comprising a plurality of electrically charged particles disposed in a fluid and capable of moving through the fluid under the influence of an electric field. In some embodiments, the electrically charged particles and the fluid are confined within a plurality of capsules or microcells or discrete droplets surrounded by a continuous phase comprising a polymeric material. In some embodiments, at least one of the first and second electrodes is interrupted by at least one non-conductive area such that electrical current must follow a non-linear path between the two contacts on that electrode. In some embodiments, at least one of the first and second electrodes is divided into a plurality of sections having differing electrical resistance per unit length. In some embodiments, at least one of the first and second electrodes is divided into a plurality of sections having differing electrical capacitance per unit area. In some embodiments, at least part of one of the first and second electrodes is provided with a passivation layer disposed between the electrode and the layer of electro-optic material. In some embodiments, the first or second time-varying drive signal comprises a sine wave, a triangular wave, a saw tooth wave, or a square wave.

In a preferred form of the spaced contact display of the present invention, both the first and second electrodes have at least two spaced contacts and a voltage controller is arranged to vary the potential differences between of the two spaced contacts attached to each electrode. Each electrode may of course have more than two spaced contacts; if this is the case, it is not essential that the voltage controller be arranged to vary the potentials of all but one of these contacts independently of each other; for example, the contacts may be divided into two or more groups, with the contacts in each group being maintained at the same potential but with a potential difference being applied between the different groups.

The spaced contact display of the present invention may have more than one electrode on each side of the layer of electro-optic medium. Indeed, in the case of very large displays (perhaps covering very large walls), it may be necessary or desirable for the display to be divided into a series of separate modules, each of which has an electro-optic layer sandwiched between first and second electrodes. Also, a spaced display of the present invention may have differing numbers of electrodes on each side of the layer of electro-optic medium.

The methods disclosed herein are also suitable for use with “isolated electrode” displays, which include a layer of electro-optic material, and a sequence of at least three electrodes disposed adjacent the layer of electro-optic material and configured to apply an electric field across the layer of electro-optic material, the electrodes on at least one surface of the layer of electro-optic material being light-transmissive, and a voltage controller arranged to vary the potential difference between the first and last electrodes of the sequence, and wherein: (a) each electrode of the sequence lies on the opposed side of the layer of electro-optic material from both the electrode which precedes it in the sequence and the electrode which follows it in the sequence; (b) each electrode of the sequence has a first edge which overlaps with or lies adjacent the electrode which precedes it in the sequence and a second edge which overlaps with or lies adjacent the electrode which follows it in the sequence; and (c) each electrode of the sequence, other than the first and last thereof, is electrically isolated such that the potential thereof is controlled by passage of current through the layer of electro-optic material.

### BRIEF DESCRIPTION OF THE DRAWINGS

FIG. 1 of the accompanying drawings is a highly schematic top plan view of a spaced contact banner display of the present invention illustrating the positions of the contacts for the top (T) and bottom (B) electrode layers.

FIG. 2 is a highly schematic section along the line II-II in FIG. 1 looking in the direction of the arrow. Notably, the contacts for the top electrode layer are on the bottom of the display while the contacts for the bottom electrode layer on the top of the display.

FIG. 3 is a schematic top plan view of an alternative construction of spaced contact display in which gaps are provided in one electrode layer so that electrical current must follow a non-linear path between the two spaced contacts of the electrode layer.

FIG. 4 is a schematic top plan view of an alternative construction of spaced contact display in which one electrode is divided into sections having differing electrical resistance per unit length.

FIG. 5 is a side view of an alternative construction of spaced contact display in which one electrode layer has regions of varying capacitance per unit area.

FIG. 6 is a side view of an isolated electrode display of the invention, wherein a series of electrodes alternate above and below a layer of electro-optic material. Each electrode of the sequence lies on the opposed side of the layer of electro-optic material from both the electrode which precedes it in the sequence and the electrode which follows it in the sequence.

FIGS. 7A to 7D show a schematic top plan view of the various layers of an electrode layer suitable for use with the invention.

FIG. 8 shows an exemplary driving scheme used in the prior art wherein two different time-varying driving waveforms are provided by the voltage controller to electrodes spaced at either end of a banner display. For both waveforms, the voltage and frequency is held constant, however the duty cycle is varied as a function of time (as determined by the frame number).

FIG. 9 illustrates a variation in duty cycle for a constant voltage and frequency.

FIG. 10 illustrates an embodiment of an improved driving method of the invention that provides for DC balanced waveforms that also allow for less “dead time” during the driving cycle.

FIG. 11 illustrates an embodiment of an improved driving method of the invention that provides for DC balanced waveforms that also allow for less “dead time” during the driving cycle.

FIG. 12 shows an exemplary wave switching banner sign indicating the location of a train station. The sign switches between black text on a white background and white text on a black background as a wave moving from left to right over about 3 seconds.

### DETAILED DESCRIPTION

The invention involves improved methods for driving “spaced contact” electro-optic displays and “isolated electrode” electro-optic displays. The improved methods provide DC balanced waveforms that diminish the amount of remnant voltage that remains between the electrodes when the driving cycle is complete. Additionally, the improved methods allow for a banner-type display to “wave” switch in a first direction and then return in an opposite direction.

In a spaced contact display, two electrode layers are disposed on either side of a layer of electro-optic media. Each electrode layer may include two contacts, and each electrode layer may simply have the form of a uniform strip of conductive film (light-transmissive of otherwise) extending between the two contacts. A voltage controller is coupled to the contacts and configured to apply a potential difference that varies with time between the pairs of contacts attached to at least one of the electrode layers. For example, the voltage controller may vary the potential differences (voltage) applied to the first and second contacts at differing frequencies. The voltage controller may vary the potential differences as, for example, a sine wave, a triangular wave, a saw tooth wave or a square wave of fixed or varying frequency or varying duty cycle.

Additionally, in spaced contact displays interesting visual effects may be produced by using non-uniform electrode layers. For example, at least one of the first and second electrode layers may be interrupted by at least one non-conductive area such that electrical current must follow a non-linear path between the two contacts on that electrode. Examples of possible geometric arrangements of such non-linear paths include stripes, spirals, and interdigitated electrodes, and are discussed below with reference to the drawings. Alternatively, at least one of the first and second electrode layers may be divided into a plurality of sections having differing electrical resistance per unit length, and/or into a plurality of sections having differing electrical capacitance per unit area. The electrode layer having two contacts may also be provided in the form of a plurality of conductive traces or areas on a backplane and configured to operate as a bus bar. In some embodiments the electrode layer may comprise a first plurality of conductive lines, a layer of insulating material applied over the first plurality of conductive lines, a second plurality of conductive lines applied to the layer of insulating material, and a layer of resistive material in electrical contact with the second plurality of conductive lines. The layer of insulating material may be configured to electrically connect each conductive trace in the first plurality of conductive lines to a single conductive line in the second plurality of conductive lines and each conductive line in the second plurality of conductive lines to a single conductive line in the first plurality of conductive lines. In yet another embodiment, the electrode layer may comprise a plurality of conductive lines, a layer of insulating material applied over the first plurality of conductive traces lines, a plurality of conductive areas applied over the layer of insulating material, and a layer of resistive material in electrical contact with the plurality of conductive areas. The layer of insulating material may be configured to electrically connect each conductive line in the plurality of conductive lines to a single conductive area and each conductive area to a single conductive line. To reduce or eliminate such damage to the electrode layers, at least part of one of the first and second electrode layers may be provided with a passivation layer disposed between the electrode layer and the layer of electro-optic material. Appropriate passivation layers are described in, for example, U.S. Pat. No. 6,724,519.

The methods disclosed herein are also suitable for use with “isolated electrode” displays, which include a layer of electro-optic material, and a sequence of at least three electrodes disposed adjacent the layer of electro-optic material and configured to apply an electric field across the layer of electro-optic material, the electrodes on at least one surface of the layer of electro-optic material being light-transmissive, and a voltage controller arranged to vary the potential difference between the first and last electrodes of the sequence, and wherein:
(a) each electrode of the sequence lies on the opposed side of the layer of electro-optic material from both the electrode which precedes it in the sequence and the electrode which follows it in the sequence;
(b) each electrode of the sequence has a first edge which overlaps with or lies adjacent the electrode which precedes it in the sequence and a second edge which overlaps with or lies adjacent the electrode which follows it in the sequence; and
(c) each electrode of the sequence, other than the first and last thereof, is electrically isolated such that the potential thereof is controlled by passage of current through the layer of electro-optic material.

In most instances, an isolated contact display (as defined above) is driven by a voltage controller configured to apply a potential difference between the first electrode and the last electrode of the display. The voltage controller may be arranged to apply a potential difference which varies with time between the first and last electrodes.

The displays and driving methods of the present invention may make use of any of the types of electro-optic media discussed above. In preferred embodiments, the electro-optic display may include an electrophoretic material comprising a plurality of electrically charged particles disposed in a fluid and capable of moving through the fluid under the influence of an electric field. The electrically charged particles and the fluid may be confined within a plurality of capsules or microcells. Alternatively, the electrically charged particles and the fluid may be present as a plurality of discrete droplets surrounded by a continuous phase comprising a polymeric material. The fluid may be liquid or gaseous. A spaced contact display comprises a layer of electro-optic material, first and second electrodes on opposed sides of the layer of electro-optic material, at least one of the first and second electrodes having at least two spaced contacts, and a voltage controller arranged to vary the potential difference between the two spaced contacts attached to the same electrode.

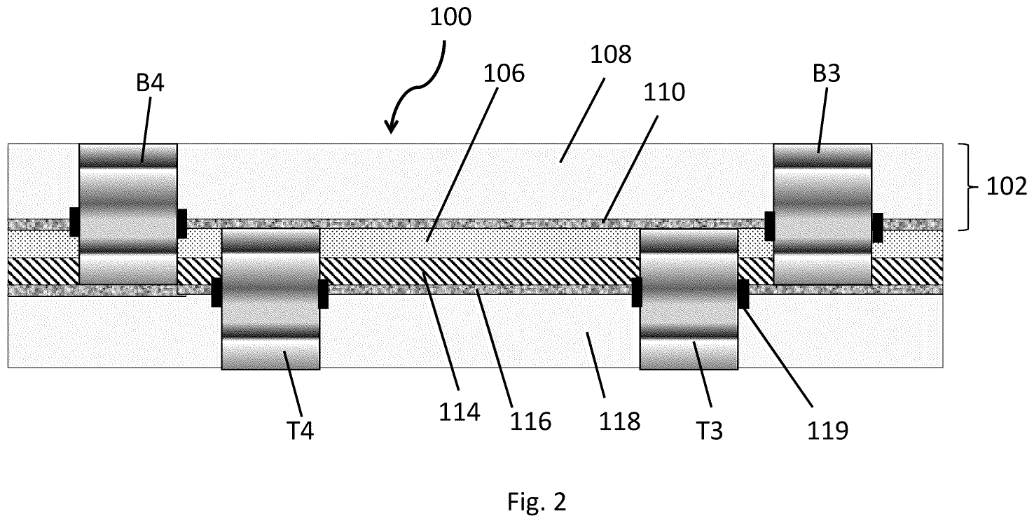

As described above, most conventional electro-optic displays, whether of the active matrix or direct drive types, use a single light-transmissive “common” electrode on the front (top; viewing) side of the electro-optic layer and an array of electrodes (either pixel electrodes or direct drive electrodes) on the opposed side of the electro-optic layer (backplane). The potential difference between each of the array of electrodes and the common electrode is controlled by the display driver or voltage controller, so that each array electrode controls (in principle) the optical state of the area of electro-optic medium lying between that array electrode and the common electrode. That is, the optical state depends upon the polarity and magnitude of the potential difference and the time for which it is applied. Typically, the potential on the “common” front electrode is controlled by a so-called “top-plane connection” which may connect to a back substrate or even go through a back substrate to provide a secure connection. See FIG. 2. It is common practice to provide multiple connections to the front electrode to reduce the risk of bad contacts, but such multiple connections are not independently controllable.

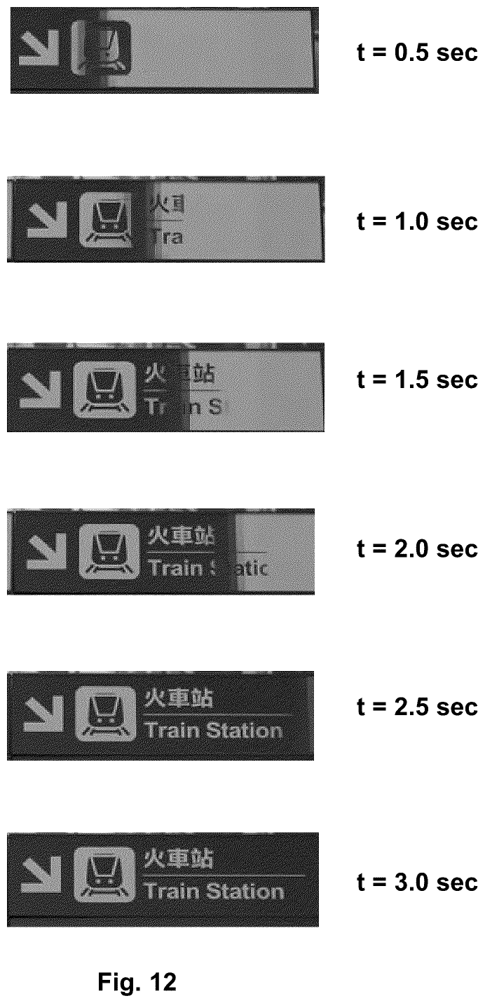

In contrast to a display having multiple top-plane connections, the spaced contact displays that use the methods of the invention rely upon potential differences between two or more spaced contacts on a single electrode layer (typically an elongated electrode layer) to generate potential gradients within that electrode layer. Such time-dependent potential differences between different areas of the single electrode layer and the electrode on the opposed side of the electro-optic layer will result in “wave switching” as shown in FIG. 12. Furthermore, if, as is typically the case, both electrode layers of the display are provided with multiple contacts, potential gradients will exist within both electrodes, and the potential difference applied to any point in the electro-optic layer will be the difference between the instantaneous potentials at a selected portion of the electro-optic material located between the two electrode layers. That is, the potential difference applied to the electro-optic material will vary continuously across the electro-optic layer, and will result in a corresponding continuous variation in the optical state of the electro-optic medium. As shown in FIG. 12, the effect is eye-catching and reasonably fast.

Since the display of the present invention is intended to operate by developing potential gradients within the electrodes (by providing, within one electrode, a potential gradient between the two or more contacts attached to the electrode), the resistance provided by the electrodes is of major importance. Too low an electrode resistance would produce excessive currents within the electrode, which may short out electronics in the voltage controller, and may cause other problems, for example excessive local heating which might damage the electro-optic layer. On the other hand, excessive electrode resistance may result in only short-range propagation of voltages from the spaced contacts, resulting in switching of only very small areas adjacent the contacts and a need for numerous contacts if the entire area of the display is to be switched. Such a situation is similar to the isolated electrode embodiments where the effect from an individual contact is limited in scope.

Furthermore, because various embodiments of the displays made according to the present invention may rely on reflected ambient light to view the images produced by the electro-optic material, light losses from the light-transmissive electrode should be minimized. For example, ambient light will travel through the light-transmissive electrode twice in the displays according to the various embodiments of the present invention, first as the ambient light travels from its source to the surface of the electro-optic material and a second when the light is reflected from the electro-optic material to the viewer. As noted above, the electrode material should form a sufficiently high conductive front electrode to ensure enough current for the uniform driving of the display. Thicker layers of electrode material will have greater conductivity; however, thicker layers will also cause increased light loss because the materials are not colorless. Indium tin oxide (ITO) is highly colored, but the effect of this color may be minimized by applying an extremely thin layer on the order of 1000-2000 Å, for example.

Although optimum electrode resistance will vary with the size of the display, the number of contacts, and the properties of the specific electro-optic medium used, the sheet resistance of the light-transmissive electrode material is preferably about 500 to about 50,000 Ohm/sq, more preferably about 1,000 to about 15,000 Ohm/sq, and most preferably about 300 to about 5000 ohms/square. Light-transmissive conductors such as PEDOT, carbon nanotubes, graphene and nanowires can of course be used if desired.

The electro-optic materials used in the displays of the present invention will normally be bistable display materials such as electrochromic, rotating bichromal member or electrophoretic materials. Such bistable materials change their electro-optic states only after exposure to electric field for significant periods, typically of the order of 0.1 to 1 second. Accordingly, the appearance of the display of the present invention is controlled not only by the potentials present on the various areas of each electrode as the potentials at the spaced contacts vary, but also by the speed at which the electro-optic material used reacts to the electric fields to which it is exposed. Also, as discussed in some of the aforementioned applications, some electro-optic materials are subject to a phenomenon known as “blooming” by which changes in potential at an electrode affect the electro-optic state of the material over an area larger than that of the electrode itself. Although blooming is often treated as a problem in electro-optic displays, since it tends to distort the image displayed, in at least some displays of the present invention blooming may actually be advantageous in hiding otherwise inactive areas of the display. For example, as already mentioned in some displays of the present invention, the first and/or second electrode may be interrupted by at least one non-conductive area such that electrical current must follow a non-linear path between the two contacts on that electrode. Blooming may be used to conceal the optical effects of such non-conductive areas. Indeed, in some cases it may be desirable to engineer the electro-optic material with increased blooming to assist in such concealment.

A typical display of the present invention may comprise the following layers in order:
(a) a transparent conductive layer (the “front electrode”) forming the viewing surface of the display;
(b) a layer of an encapsulated electrophoretic medium;
(c) a layer of lamination adhesive; and
(d) a “backplane” comprising of a substrate (typically a polymeric film) and
a conductor which need not be transparent
   A least two areas of each electrode in layers (a) and (d) are cleaned to expose the conductor for electrical contacts, which can be independently addressed. Finally, the display comprises a voltage controller to drive the front electrode and the backplane to positive and negative potentials relative to each other, and to produce a potential gradient within each electrode.

Such a display has been produced using the following materials. The front electrode was formed of 5 mil (127 μm) polyethylene terephthalate coated on one surface with ITO, grade OC300 or 450. Alternatively, the front electrode can be coated on to the remaining layer of the display without any supporting substrate. The encapsulated electrophoretic medium was substantially as described in U.S. Pat. No. 8,270,064, and the lamination adhesive was a 25 μm layer substantially as described in U.S. Pat. No. 7,012,735 containing 5000 ppm of tetrabutylammonium hexafluorophosphate dopant to control electrical properties. The backplane was a PET/ITO film similar to that used for the front electrode, but a printed carbon conductor or other low cost transparent or non-transparent conductor could be substituted.

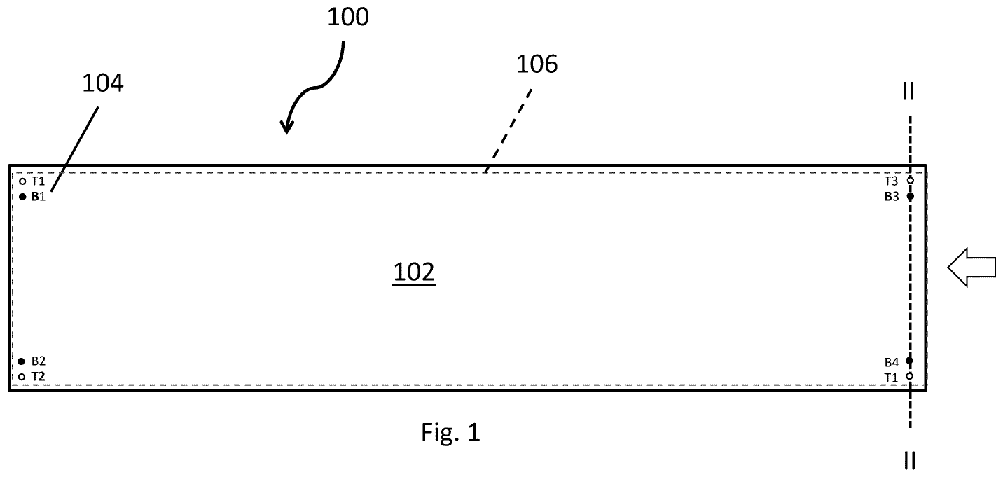

An elongated banner “spaced contact” display is illustrated schematically in FIGS. 1 and 2 of the Drawings. As shown in FIG. 1, the elongate spaced contact display (generally designated 100) comprises an elongate rectangular light-transmissive electrode 102, which is typically commercially supplied PET-ITO (Saint-Gobain). The electro-optic display material, generally designated 106, is supported from beneath by a substrate 118.

As shown in FIG. 2, the elongated spaced contact display 100 comprises an elongated rectangular light-transmissive electrode 102, which includes a PET film 108 bearing an ITO front electrode 110 which extends across the entire area of the display 106. In contact with the front electrode 110 is the electro-optic display material 106, which may be an encapsulated electrophoretic medium, the lower surface of the electro-optic display material 106 contacts a layer of lamination adhesive 114, which secures the encapsulated electrophoretic medium 112 to a backplane comprising a layer of ITO electrode 116 on a glass substrate 118. As shown in FIG. 1, the front electrode 102 is provided with four contacts T1-T4 arranged close to the corners of the elongate spaced contact display 100, while the back electrode 116 is similarly provided with four contacts B1-B4 arranged in a similar manner.

FIG. 2 illustrates the construction of contacts T1-T4 and B1-B4. The contacts B1-B4 are produced by kiss cutting apertures through the PET film 108, typically with a laser cutter, and cleaning the underlying portions of the electrophoretic medium 106 and the lamination adhesive 114. Similarly, the contacts T1-T4 are produced by cutting apertures through the glass substrate 118 and cleaning the overlying portions of the electrophoretic medium 106 and the lamination adhesive 114 using solvent and rubbing either by hand or with mechanical means like an electric toothbrush. The resultant apertures are filled with a conductive material, for example a carbon-filled adhesive, a conductive ink, or a silver paste, to produce contacts which can be addressed individually. Optionally, an insulating material 119, such as a clear non-conductive polymer may be applied around the through-hole in the opposing electrode layer to prevent shorts. A voltage controller capable of driving contacts T1-T4 and B1-B4 independently to positive and negative potentials in a time-dependent fashion is provided by a display controller (not shown) having 12 outputs each capable of supplying any voltage and waveform between ±30 V programmable on each channel independently, 30V and also having a high impedance or float state. The controller has one drive line for each output, direct drive.

The display shown in FIGS. 1 and 2 may be constructed substantially as described in the aforementioned U.S. Pat. No. 6,982,178. A PET/ITO film (i.e., the PET film 108 and the ITO electrode 110) is coated with, or laminated to, an electrophoretic medium 106 to form a PET/ITO/electro-optic subassembly. An ITO-glass substrate (i.e., the lower substrate 118 and the bottom ITO electrode 116) is laminated to the subassembly with the lamination adhesive 114. In an alternative embodiment, the lower ITO electrode 116 may be replaced with a non-light transmissive electrode without repercussion because the electrophoretic medium 112 does not transmit light. The resultant structure is a full electro-optic display capable of switching given correct electrical connections. Using such techniques, it is possible to create individual displays, that are 16×60 inches (406×1523 mm) or larger. Other construction methods could also be used, for example formation of a front plane laminate (FPL) as described in the aforementioned U.S. Pat. No. 6,982,178, followed by cutting of the FPL being cut to size before lamination to the backplane. The substrate in the kiss cut area is removed and then the electrophoretic media is cleaned. The greater the number of contacts and the spatial distribution of these contacts around the periphery of the display, the more complex the pattern of switching that can be affected.

The display 100 shown in FIGS. 1 and 2 may be driven by the voltage controller (not shown) by setting top contacts T2 and T3 (at diagonal corners of display 100) to −20V and +20V respectively, while backplane contacts B2 and B3 are set to ground, with all of the other remaining contacts (T1, T4, B1, B4) allowed to float. If this driving pattern is maintained for more than about 1 second, the optical state of the electrophoretic layer will be half dark and half white with a diffuse gradient area in the center (see FIG. 12 at 1.5 sec). If the driven contacts T2 and T3 are fed variable voltage patterns instead of fixed voltages, moving patterns are produced in the electrophoretic layer. For example, if one contact receives a 20V amplitude sine wave at 0.1 Hz frequency and the other driven contact on the same electrode receives a 20V amplitude sine wave at 0.09 Hz frequency, a wave of black to white switching will move slowly across the display with different speeds and different directions, left to right or right to left, varying with time due to the differing frequency of the two sine waves supplied. The speed and direction of the moving wave of white to black or black to white can be made to be constant and repeating by making the frequency of the two sine waves the same and giving them a constant phase difference. More complex patterns can be formed by driving two contacts at opposite ends of a diagonal of the display, especially if the opposite diagonals contacts are used in the top and bottom electrodes. Still more complex patterns can be produced by providing a larger number of contacts around the periphery of the display.

Although the display shown in FIGS. 1 and 2 has electrodes in the form of simple rectangles, so that each electrode layer is essentially uniform between the spaced contacts at its two ends, it should be understood that methods for improved wave switching (described below) are not restricted to rectangular or any particular shape of displays, and interesting effects can be produced using polygonal (for example, hexagonal or octagonal) displays, or circular or elliptical displays. In such cases, one or more contacts may be provided around the periphery of the display and another contact in the center of the display so that changes in the electro-optic material propagate radially rather than linearly. Furthermore, the present invention is not confined to planar, two-dimensional displays, but may be applied to three-dimensional objects. Both electrodes and electro-optic media can be deposited on three-dimensional objects; for example, electrodes formed from organic conductors may be deposited from solution and electrophoretic media may be deposited by spray techniques.

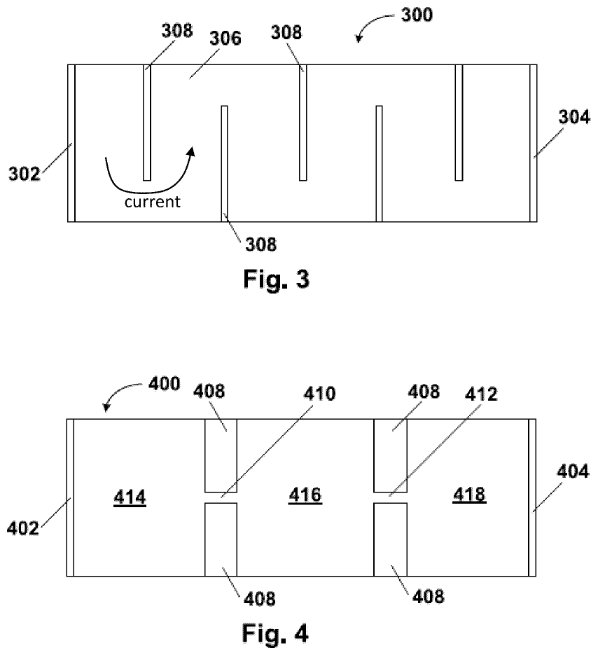

Furthermore, interesting optical effects may be obtained by providing gaps in one or both electrodes, for example by removing or chemically altering the electrode material, so that electrical current must follow a non-linear path between the two contacts on that electrode. FIG. 3 is a schematic top plan view of a display (generally designated 300) of this type. As with the elongated spaced contact display 100 shown in FIGS. 1 and 2, the display 300 has the form of an elongate rectangle, with strip contacts 302 and 304 provided at it opposed ends. (The contacts do not need to be pads, and there need not be more than one contact at each end.) The electrode layer 306 extending between the contacts 302 and 304 is interrupted by a plurality of non-conductive areas 308 so that electrical current (and thus electro-optic effects) must follow a substantially sinusoidal course between the contacts 302 and 304. The non-conductive areas 308 do not require exotic materials, and may be achieved by simply scraping the ITO from the PET over a width sufficient to block shorting across the removed ITO, i.e., 5 mm.

Non-conductive areas, such as non-conductive areas 308 in FIG. 3, can be used to “channel” electro-optic effects in a variety of interesting patterns. For example, a circular, elliptical or polygonal display may have a single contact on the periphery of the display, a second contact at the center of the display, and a spiral non-conductive areas to channel electro-optic effects along a spiral electrode extending between the two contacts. Even greater freedom of design is available in the case of three-dimensional displays; for example, a display formed on a cylindrical substrate could use a helical non-conductive area to channel electro-optic effects along a helical path between contacts provided at opposed ends of the cylindrical substrate.

As already mentioned, in a spaced contact display of the present invention, at least one of the first and second electrodes may be divided into a plurality of sections having differing electrical resistance per unit length, and a schematic top plan view of such a display (generally designated 400) is shown in FIG. 4. The display 400 is generally similar to the display 300 shown in FIG. 3 in that the display 400 has the form of an elongate rectangle provided at its opposed ends with contacts 402 and 404. Also, like the display 300, the display 400 is provided with non-conductive areas 408. However, the arrangement of the areas 408 differs from that of the areas 308 in FIG. 3; the areas 408 are in the form of two adjacent pairs of area extending from opposed long edges of the display 400 so as to leave between each adjacent pair a narrow “neck” or “isthmus” of conductive material 410 or 412. Thus, current passing between the contacts 402 and 404 passes successively through a low resistance region 414, the high resistance neck 410, a low resistance region 416, the high resistance neck 412 and a low resistance region 418.

FIG. 4 illustrates the formation of regions of varying resistance by varying the width of the electrode, but of course other techniques for varying resistance could be employed. For example, the display shown in FIG. 4 could be modified by replacing each neck region 410 and 412 with contacts provided on the adjacent regions and interconnected via an appropriate resistor. To avoid the unsightly presence of visible electrical components, resistors and associated conductors could be accommodated within the frame surrounding the display, such as is often present in, for example, frames for signs. The ability to interconnect electrode regions “invisibly” by means of electrical components disposed within such a frame does provide an additional degree of design freedom, namely the ability to arrange electrode segments electrically in an order which differs from their physical location. For example, consider a modified version of the display 400 in which the electrode is divided into five segments (designated for convenience A, B, C, D and E reading left to right in FIG. 4) rather than the three segments 414, 416 and 418 shown in FIG. 4, with the segments A-E being interconnected via conductors and resistors hidden within a frame. The electrical interconnections could be arranged so that the electrodes segments are electrically interconnected in the order (say) A, D, B, C, E, which will produce electro-optic effects which appear to jump around the display rather than progressing linearly along it as in the display 100 shown in FIGS. 1 and 2.

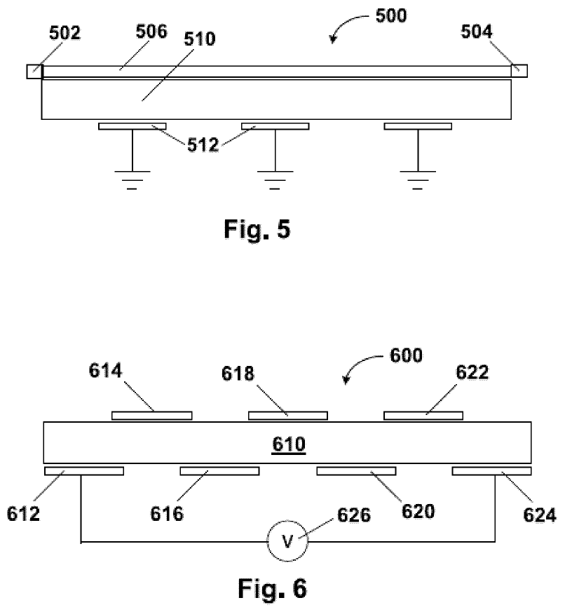

Instead of providing regions of various resistance within an electrode, regions of varying capacitance may be used, and a schematic cross-section through such a display (generally designated 500) is shown in FIG. 5. The display 500 is generally similar to the displays 300 and 400 shown in FIGS. 3 and 4 respectively inasmuch as it has the form of an elongate rectangle with an electrode 506 provided with contacts 502 and 504 at its opposed ends. However, unlike the illustrated electrodes of the displays 300 and 400, electrode 506 of display 500 is uninterrupted. However, electrode 506 is provided with regions of varying capacitance per unit area by providing, on the opposed side of electro-optic medium from electrode 506 a series of spaced electrodes 512, all of which are grounded. It will readily be apparent that regions of the electrode 506 lying opposite electrodes 512 will have a substantially greater capacitance per unit area than regions of the electrode 512 which do not lie opposite electrodes 512, thus providing variations in the electro-optical performance of the display 500 generally similar to those provided by the regions of varying resistance in display 400. (Typically, an adhesive layer similar to adhesive layer 114 shown in FIG. 2 will be present either between electro-optic layer 510 and electrode 506 or between electro-optic layer 510 and electrodes 512. The adhesive layer is omitted from FIG. 5 for ease of illustration but its presence or absence makes no difference to the fundamental manner of operation of display 500.)

One embodiment of an isolated electrode display of the present invention will now be described with reference to FIG. 6. Conceptually, an isolated electrode display might be regarded as a modification of the variable resistance electrode display of the type shown in FIG. 4, with the modification comprising using the electro-optic layer itself as the high resistance regions between the low resistance electrodes. This modification places successive high resistance regions (electrodes) on opposed sides of the electro-optic layer, so that only a single set of electrodes are required.

More specifically, as shown in FIG. 6, the isolated electrode display (generally designated 600) has the form of an elongate rectangle similar to that of the displays comprises a layer 610 of electro-optic material and a sequence of seven electrodes 612-624, each of which has the form of an elongate strip extending across the full width of the display. The first and last electrodes 612 and 624 respectively are connected to a voltage control unit (indicated schematically at 626) which enables a time varying potential difference to be applied between electrodes 612 and 624. The remaining electrodes 614-622 are electrically isolated so that their potentials are controlled by passage of current through the layer 610 of electro-optic material. The electrodes 612-624 alternate between the lower and upper surfaces (as illustrated) of the layer 610, and the electrodes 614, 618 and 622 on the upper surface (which is the viewing surface of the display) are light-transmissive; the electrodes 612, 616, 620 and 624 may or may not be light-transmissive. As may be seen from FIG. 6, each of the electrodes 614-622 has a first edge (its left-hand edge as illustrated in FIG. 6) which overlaps with the preceding electrode and a second edge (its right-hand edge as illustrated in FIG. 6) which overlaps with the following electrode. It is not necessary that the adjacent edges overlap provided that they lie adjacent each other so as to leave a conductive path of reasonable length through the layer 610. It will be appreciated that it is not necessary that the first and second edges of the electrodes be on opposed sides of the electrode. For example, the electrodes 612-624 could be in the form of isosceles triangles, so that the first and second edges would not be parallel, or the electrodes could be arranged in the form of a checkerboard, in which case some electrodes would have first and second edges at right angles to each other.

Application of a time-varying potential difference by a voltage controller 626 between electrodes 612 and 624 will cause a complex variation in the potentials of the electrodes 614-622, depending upon factors such as resistivity of the layer 610, the capacitances between the electrodes, polarization within the layer 610, etc., and an even more complex variation in the optical state of the various parts of the layer 610. Most commonly, the various parts of the layer 610 will be perceived to “flicker” as the voltage applied by the voltage controller 626 is varied.

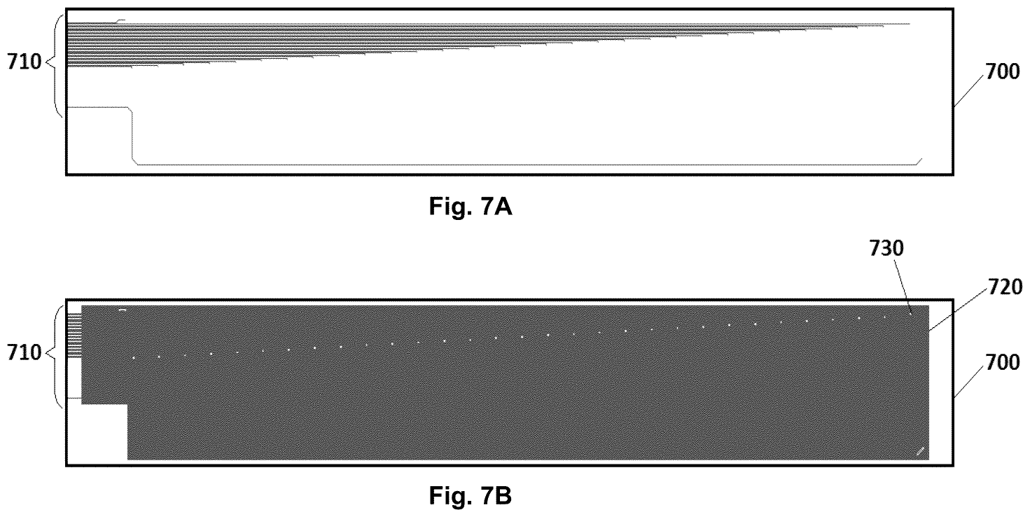

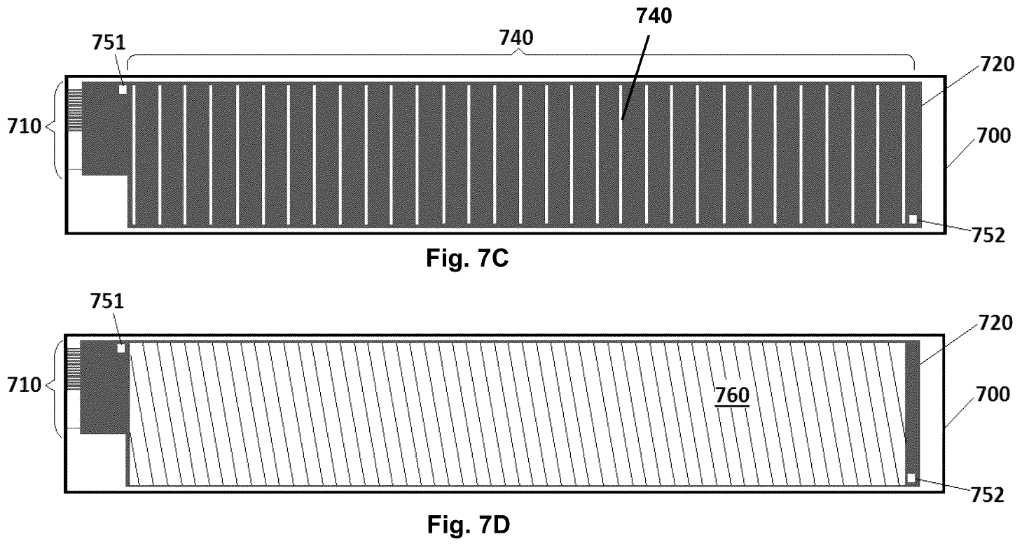

In yet another embodiment, a display may be fabricated to include a backplane that is configured to accomplish a low power wave switch. Referring to FIGS. 7A to 7D, the backplane may comprise a rectangular substrate 700 on which a first plurality of conductive lines or traces 710 of varying lengths may be printed. One end of each of the conductive lines 710 may be connected to a drive circuit or voltage controller (not shown). A layer of insulating material 720 may then be applied over the first plurality of conductive lines 710, except for a plurality of voids 730 leaving the unconnected ends of the first plurality of conductive lines 710 exposed. A second plurality of conductive lines or traces 740 may be applied over the layer of insulating material 720, such that each of the conductive lines 740 traverses and is in electrical contact with a respective first conductive line 710, but only one of the first conductive lines 710. This may be achieved by printing the second plurality of conductive lines 740 over the voids 730 in the insulating material 720. The location of the voids in the layer of insulating material and the second plurality of conductive lines are precisely located to prevent an electrical short between unassociated conductive lines. Therefore, each conductive line in the first plurality is in electrical with only one line within the second plurality and vice versa. One or more contact pads 751, 752 may also be applied to an exposed end of a first conductive line 710. The one or more contact pads 751,752 may provide a location for electrically connecting the backplane to the light-transmissive front electrode (not shown) of the display. Finally, a layer of resistive material 760 may be applied over the second plurality of conductive lines 740, such that the layer of resistive material 760 is in electrical contact with the second plurality of conductive lines 740. The layer of resistive material is preferably the top-most layer of the backplane and will be in direct contact with a front plane laminate (FPL) of the display.

Each of the components in the backplane may be easily fabricated using techniques known by those of skill in the art, such as the methods for manufacturing multi-layered printed circuit boards. Various materials may be used for the various layers of the backplane. For example, materials for the insulating layer include, but are not limited to, dielectric materials, preferably, dielectric materials comprising photo-curable solvent free organic or silicone based oligomers. Examples of materials that may be used in the resistive layer include, but are not limited to, resistive carbon, ITO filled polymers, PEDOT filled polymers, and metal fillers. Similarly, any conductive material may be used to print the first and second plurality of conductive lines, such as carbon or conductive metals, like silver, nickel, and copper.

The material for forming the second plurality of conductive lines preferably has a higher conductivity than the material used to form the layer of resistive material. The combination of the second plurality of conductive lines and layer of resistive material essentially provides a series of highly conductive bus bars in which the conductive lines serve as individual bus bars because the resistive material layer ensures uniform voltage around each line. The resistance of the layer of resistive material may be selected relative to the length and spacing between the bus bar lines. Preferably, the total resistance between bus bar lines is greater than or equal to 1 kOhm, more preferably greater than or equal to 10 kOhm for reduced power consumption. For example, in a configuration in which the length to spacing ratio of the bus bar lines is 10, providing a resistive layer having a resistivity of 10 kOhms/square results in a total resistance between the bus bar lines of 1 kOhm.

In another embodiment of the present invention, a method of driving a display having the above-described backplane is provided. To drive the display, a driver with bi-level or tri-level output capability may be used, which also preferably has a floating (high impedance) output capability. Referring again to FIGS. 7A to 7D, the driver may be connected to the first plurality of conductive lines 710 along the left side of the substrate 700. In a first step, the driver may apply voltage to the leftmost bus bar line (“first bus bar line”) of the second plurality of conductive lines 740 and short or float the remaining bus bar lines. As used herein throughout the specification and the claims, “short” or “shorting” means to ground a conductive line or area, and “float” or “floating” means to electrically isolate a conductive line or area. The electro-optic media within the FPL that is located in proximity to the leftmost bus bar line will switch immediately and a color gradient from switched to unswitched electro-optic media will appear between the first bus bar line and the subsequent bus bar line (“second bus bar line”). If the voltage controller is capable of pulse width modulated (PWM) or voltage modulated (VM) output, the driver may gradually increase the duty cycle or voltage to create a more slowly developing gradient. After some period of time, the length of which may be determined by the switching speed required by the application, the driver may apply voltage to the second bus bar line, while ending the voltage application on the first bus bar line, and so on. In this manner, the driver may gradually switch the electro-optic media across the entire display in a controlled fashion while limiting the application of voltage to only the area where the gradient between switched and unswitched electro-optic media exists. Fortunately, high end function generators are not necessary for PWM and VM output, and may be achieved with, for example, Lab VIEW programming kits, Arduino boards coupled to a suitable voltage supply, or certain off the shelf EPD drivers, such as available from ULTRACHIP.

If a wider gradient is desired, for example, the driver may apply voltage on multiple adjacent bus bar lines, timed in succession, so as to gradually spread the gradient across the display. Finally, a gradient may be created at any location in the display and multiple gradients may exist simultaneously by applying a pattern of opposing voltages on multiple bus bar lines. The gradient can start and stop at any point on the display or at any time, and if multiple gradients are generated simultaneously, the gradients may propagate in multiple directions at multiple speeds. The wave complexity is therefore dependent on the bus bar line spacing and the software control for the driver.

As explained above, the layer of insulating material between the first and second plurality of conductive lines connects the drive circuit to remote areas of the backplane. The various conductive lines are able to cross each other without electrically shorting each other. This configuration allows for various backplane designs. For example, a backplane having similar printed layers as the previously described rectangular backplane may instead be provided on a circular substrate.

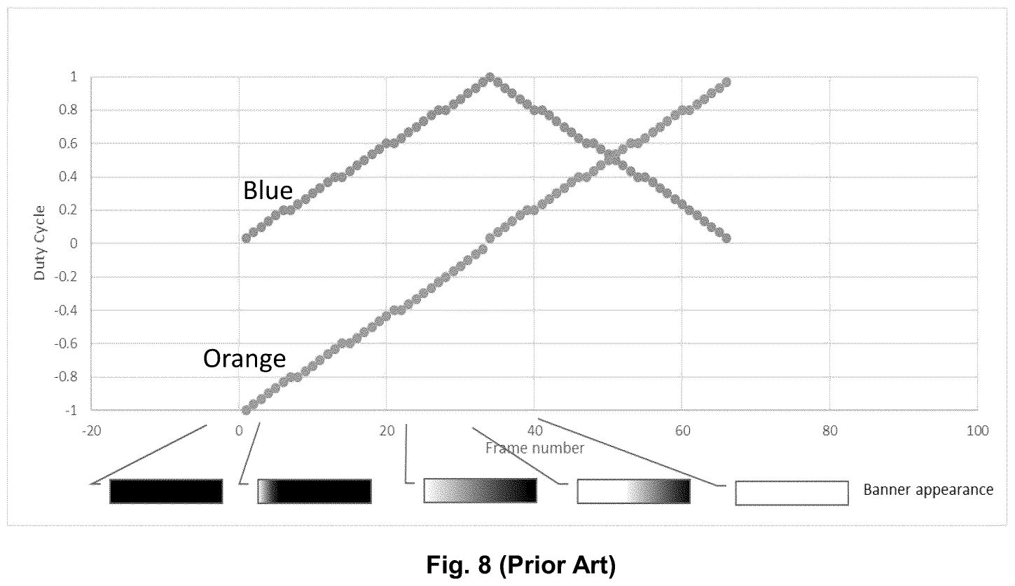

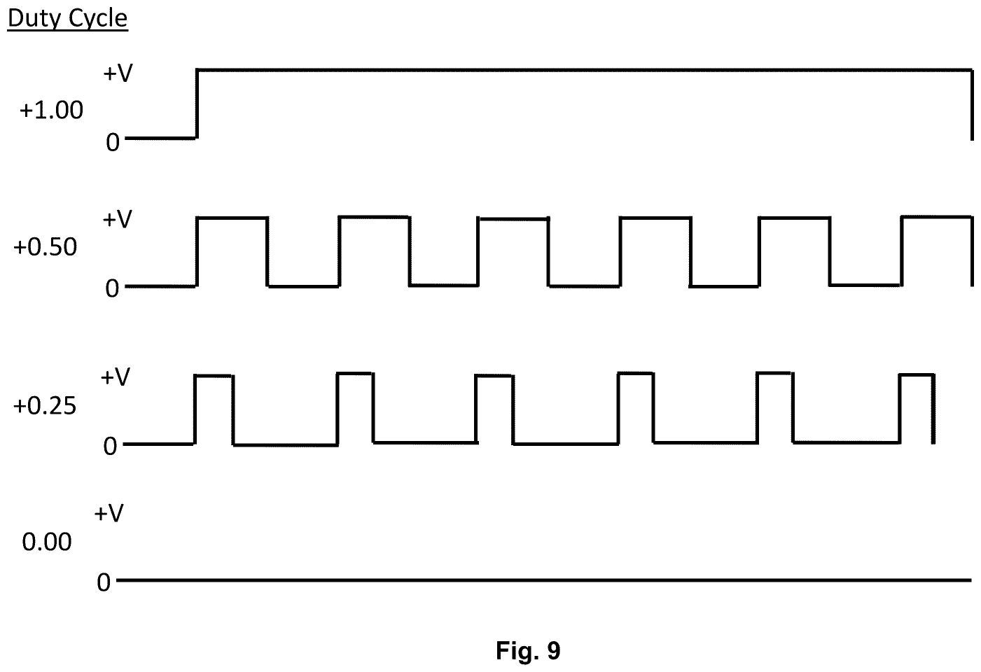

A (prior art) PWM drive scheme for the display of FIGS. 7A-7D is depicted in FIG. 8. In FIG. 8, a driving signal with a frequency of 30 Hz and +15V has a variable duty cycle ranging from −1 to 1, which can be visualized by regarding FIG. 9. The duty cycles of 0 to −1 (i.e., negative duty cycles) correspond to the duty cycles of 0 to 1 shown in FIG. 9 except that the voltage is −V, i.e., −15V. Applying the blue driving signal to one corner contact (e.g., pad 751) of an elongated spaced contact display 700 while applying the orange driving signal to the other corner contact (e.g., pad 752) produces the switching effect shown along the bottom of FIG. 8. It should be understood that the method depicted in FIG. 8 is generally applicable to driving elongated spaced contact displays or isolated electrode displays (e.g., FIG. 6). Additionally, the blue driving signal has been supplemented with a solid black line for easier visualization.

Returning to FIG. 8, the transition will begin on the banner side with the blue driving signal (a.k.a. “left side”) and the transition will appear to end on the side with the orange trace applied (a.k.a. “right side”). The orange driving signal has been supplemented with a dashed black line for easier visualization. This plot shows a single transition from one rail state to the other, for example, from black to white, as depicted along the bottom of FIG. 8. Once in the white state, it is possible to drive the display from white to black by reversing the duty cycle signals provided to both contacts. However, the wave switching will again be from left to right.

Importantly, as shown in FIG. 8, the visible transition will appear complete around frame 40, when the trailing (orange) waveform has risen significantly above 0. [As used herein, “frame” is a unit of time representing a step from a first duty cycle to the next adjacent duty cycle. The size of a frame is somewhat arbitrary, however for optimal performance, and to prevent damage to the display, each frame of FIG. 8 is around 100 ms, e.g., 80 ms. Accordingly, the number of voltage pulses at a given duty cycle is on the order of 2-5 at +V; not as long as depicted in FIG. 9, which is merely for explanation.] From frame 40 to frame 66, however, there will be negligible change in the visual appearance of the display, which means that there is an inherent rest period before the banner can be switched back to the opposite color. If the transition shown in FIG. 8 is followed immediately by a wave in the same direction (left to right) going from (now) white to black, the visual effect won't start until after about frame 67, or more than two seconds after the first switch appeared to be complete.

Fortunately, the combined two transitions (black to white and white to black) moving in the same direction (left to right) result in a DC balanced pair, which reduces wear and tear on the display, although approximately ⅖ of the time there is no discernable visual effect. However, DC balance is only achieved going from (black to white and white to black) and moving in the same direction (left to right). Note in FIG. 8 that the orange trace is DC balanced while the blue trace is entirely positive, and thus not DC balanced. Accordingly, if the display is not switched back to the original color, the excess charge can damage the display. Worse still, if the direction is reversed (right to left) for the return transition (white to black), i.e., the opposite polarity blue trace is applied to the right side and opposite polarity orange to the left side, the DC imbalance is doubled(!) which will cause the display to rapidly degrade. Thus, using the drive scheme of FIG. 8, it is impossible to achieve back and forth wave switching, i.e., “ping-pong switching” without substantially degrading the display. Lastly, it should be noted that the orange trace finishes at 100% duty cycle, which is essentially the rail voltage (see FIG. 9). If a one-way transition is followed by a delay or “rest”, the electrophoretic medium will kick-back away from the destination rail state, resulting in a final state that is less saturated than desired.

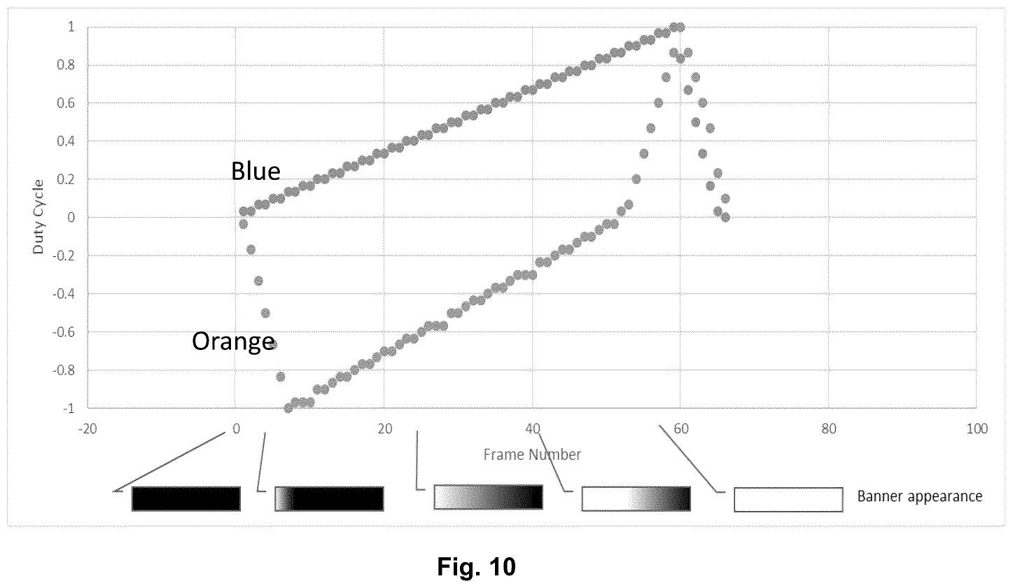

In view of the limitations of the prior art driving, there is a need for improved wave switching methods for spaced contact and isolated electrode displays, i.e., of the types discussed above. FIG. 10 shows improved waveforms that can be used for an elongated spaced contact display using PWM or VM driving. In particular, the waveform of FIG. 10 greatly reduces the relative amount of time that the display is not visibly changing optical state, going from about 40% not visibly switching for the drive scheme with respect to FIG. 8 to about 10% not visibly switching for the drive scheme with respect to FIG. 10. The waveforms of FIG. 10 also reduce kickback when a rest is inserted at the end of driving. The two significant changes from the prior art method (FIG. 8) are visible in the blue and orange lines at the beginning and end of the transition. At the beginning, the orange line's (right side) duty cycle is smoothly (but rapidly) increased from 0 to −1, eliminating the sudden jump in state experienced with the orange line of FIG. 8. At the end of the transition, a smooth decrease in the orange line (right side) duty cycle from 1 to 0 eliminates the kickback. Also, the visual transition occurs approximately between frames 0 and 55, providing a significant reduction in non-active time. Each end of this waveform is still DC imbalanced, but it does provide a smooth transition with minimal time between successive updates at each rail state. At the same time, the blue line (left side) has been elongated for the visual transition to match the orange line, while the blue line still returns from a duty cycle of 1 to a duty cycle of 0, as in FIG. 8, but after the visible transition has completed.

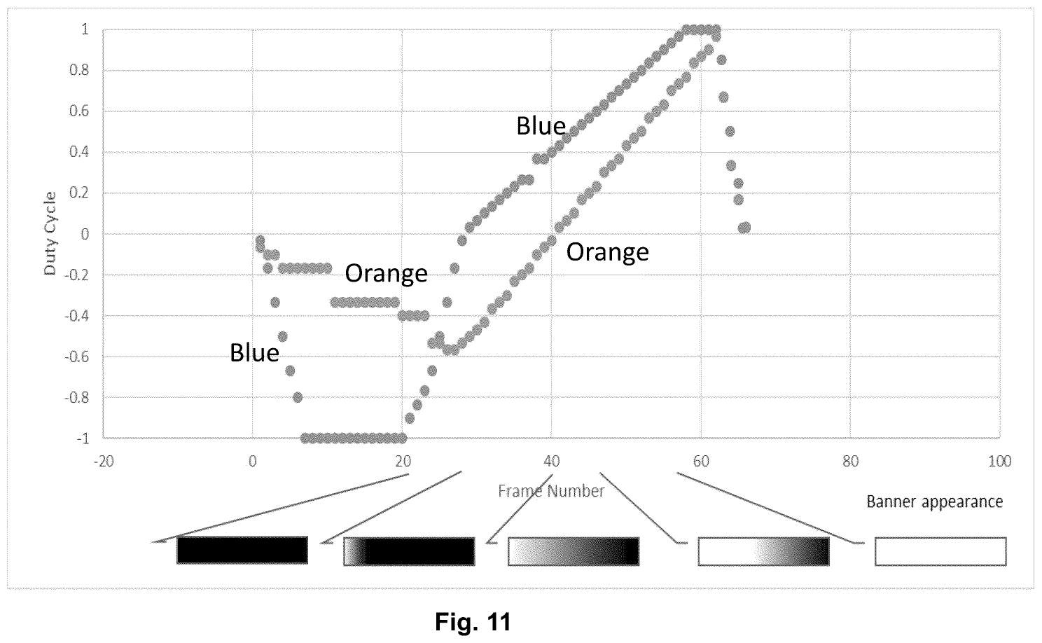

An alternative drive scheme for an elongated spaced contact display using PWM or VM driving is shown in FIG. 11. The drive schemes of FIG. 11 additionally provide DC balance at the end of each wave switch, however the driving is more complicated than FIG. 10 and may require a more elaborate voltage controller. While both the blue (left) and orange (right) drive schemes begin with a duty cycle of zero, like FIG. 10, the first 28 frames of the transition are used to DC balance both the blue and orange waveforms. Then beginning at approximately frame 30, the wave will begin at the left side of the display. At approximately frame 55, the right side of the display will appear to finish its transition. To achieve DC balance, both drive schemes need to run to completion, resulting in a not visibly switching time of about 20%, which is worse than FIG. 10. However, the DC balancing in the drive schemes of FIG. 11 allows the display to reverse direction for the very next transition, i.e., achieve the desired “ping-pong switching.” Reverse direction driving can be achieved by essentially providing the blue drive scheme at the right contact and the orange drive scheme at the left contact, or by flipping the direction and polarity of both the blue and orange drive schemes, while providing the the modified blue and orange drive schemes to the left and right contacts, as is done with the previous drive schemes.

From the foregoing, it will be seen that the present invention provides a display and driving method that enable moving changes in the optical state of an electro-optic medium (especially a bistable medium, such as an electrophoretic medium) and generation of patterns of visual interest with very simple, inexpensive electrodes. The patterns of visual interest can be used to direct a viewer or call attention to content that would otherwise be static, such as provided with a segmented electrode display, e.g., as demonstrated in FIG. 12.

It will be apparent to those skilled in the art that numerous changes and modifications can be made in the specific embodiments of the invention described above without departing from the scope of the invention. For example, variable voltages are not, of course, confined to simple sine waves; triangular waves, saw tooth waves and square waves of fixed or varying frequency may all be employed. Accordingly, the whole of the foregoing description is to be interpreted in an illustrative and not in a limitative sense.

1. A method for driving a spaced contact electro-optic display, comprising:
providing a spaced contact electro-optic display including:
a layer of electro-optic material, first and second electrode layers on opposed sides of the layer of electro-optic material wherein the first or the second electrode layer is light-transmissive,
first and second contacts spaced apart on, and electrically coupled to, the first electrode layer, and
a voltage controller coupled to the first and second contacts;
providing a first time-varying drive signal to the first contact with the voltage controller, wherein the first time-varying drive signal begins at a duty cycle of zero, ramps to a duty cycle of 1, and then returns to a duty cycle of zero; and
providing a second time-varying drive signal to the second contact with the voltage controller, wherein the second time-varying drive signal begins at a duty cycle of zero, ramps to a duty cycle of −1, then ramps to a duty cycle of 1, and then returns to a duty cycle of zero.

2. The method of claim 1 wherein the ramp from a duty cycle of −1 to a duty cycle of 1 for the second time-varying drive signal includes two different slopes of duty cycle per unit of time.

3. The method of claim 1, further comprising:
providing a third time-varying drive signal to the first contact with the voltage controller, wherein the first time-varying drive signal begins at a duty cycle of zero, ramps to a duty cycle of −1, and then returns to a duty cycle of zero; and
providing a fourth time-varying drive signal to the second contact with the voltage controller, wherein the second time-varying drive signal begins at a duty cycle of zero, ramps to a duty cycle of 1, then ramps to a duty cycle of −1, and then returns to a duty cycle of zero.

4. The method of claim 1, wherein the first time-varying drive signal and the second time-varying drive signal reach a duty cycle of 1 at the same time

5. The method of claim 1, wherein the frequency of the first and second drive signals is 30 Hz or greater.

6. The method of claim 1, wherein the magnitude of the voltage of the first and second drive signals is from 15V to 30V.

7. The method of claim 1, wherein at least one of the first and second electrodes is interrupted by at least one non-conductive area such that electrical current must follow a non-linear path between the two contacts on that electrode.

8. A method for driving a spaced contact electro-optic display, comprising:
providing a spaced contact electro-optic display including:
a layer of electro-optic material, first and second electrode layers on opposed sides of the layer of electro-optic material wherein the first or the second electrode layer is light-transmissive,
first and second contacts spaced apart on, and electrically coupled to, the first electrode layer, and
a voltage controller coupled to the first and second contacts;
providing a first time-varying drive signal to the first contact with the voltage controller, wherein the first time-varying drive signal begins at a duty cycle of zero, ramps to a duty cycle of −1, maintains a duty cycle of −1 for a sufficient time to provide DC balance to the first time-varying drive signal, then ramps to a duty cycle of 1, and then returns to a duty cycle of zero; and
providing a second time-varying drive signal to the second contact with the voltage controller, wherein the second time-varying drive signal begins at a duty cycle of zero, transitions to a duty cycle of 1 by going through negative duty cycle impulses until the first time-varying drive signal is maintained a duty cycle of −1 and then proceeds to a duty cycle of 1, and then returns to a duty cycle of zero.

9. The method of claim 8, further comprising:
providing a third time-varying drive signal to the first contact that is identical to the second time-varying drive signal; and
providing a fourth time-varying drive signal to the second contact that is identical to the first time-varying drive signal.

10. The method of claim 8, wherein the first time-varying drive signal and the second time-varying drive signal reach a duty cycle of 1 at the same time.

11. The method of claim 8, wherein the frequency of the first and second drive signals is 30 Hz or greater.

12. The method of claim 8, wherein the magnitude of the voltage of the first and second drive signals is from 15V to 30V.

13. The method of claim 8, wherein both the first and second electrodes have at least two spaced contacts and the voltage controller is arranged to vary the potential differences between of the two spaced contacts attached to each electrode.

14. The method of claim 8, wherein the electro-optic material comprises an electrophoretic material comprising a plurality of electrically charged particles disposed in a fluid and capable of moving through the fluid under the influence of an electric field.

15. The method of claim 14, wherein the electrically charged particles and the fluid are confined within a plurality of capsules or microcells or discrete droplets surrounded by a continuous phase comprising a polymeric material.

16. The method of claim 8, wherein at least one of the first and second electrodes is interrupted by at least one non-conductive area such that electrical current must follow a non-linear path between the two contacts on that electrode.

17. The method of claim 8, wherein at least one of the first and second electrodes is divided into a plurality of sections having differing electrical resistance per unit length.

18. The method of claim 8, wherein at least one of the first and second electrodes is divided into a plurality of sections having differing electrical capacitance per unit area.

19. The method of claim 8, wherein at least part of one of the first and second electrodes is provided with a passivation layer disposed between the electrode and the layer of electro-optic material.

20. The method of claim 8, wherein the first or second time-varying drive signal comprises a sine wave, a triangular wave, a saw tooth wave, or a square wave.
